(19) United States
(12) Patent Application Publication
(10) Pub. No.: US 2026/0314775 A1
(43) Pub. Date: Oct. 15, 2026

(54) COMBINATION UTENSIL AND MEDICINE HOLDER

(71) Applicants: Christopher Michael Mahr, Sumter, SC (US); Jeanna Christine Mahr, Sumter, SC (US)

(72) Inventors: Christopher Michael Mahr, Sumter, SC (US); Jeanna Christine Mahr, Sumter, SC (US)

(21) Appl. No.: 19/463,391

(22) Filed: Jan. 29, 2026

Related U.S. Application Data
(60) Provisional application No. 63/751,066, filed on Jan. 29, 2025.

(51) Int. Cl. A45C 11/00; A46B 17/08; A47B 88/497; A61J 1/03; A61J 1/16; E05C 3/06

(52) U.S. Cl. CPC A45C 11/008; A46B 17/08; A47B 88/497; A61J 1/03; A61J 1/16; E05C 3/06; A45C 2011/007; A46B 2200/1066

(57) ABSTRACT

A combination utensil-medicine holder includes a base portion and a side portion. The holder includes a top portion that defines a utensil aperture. The holder includes a paddle assembly rotatably coupled with the side portion. The paddle assembly includes a paddle and a neck. The neck rotates between holding position and a free position. The holder includes a cam rotatably coupled with the neck. The cam rotates between a level position and a non-level position. The holder includes a gate selectively engaged with the cam. The holder includes a latch rotatably coupled with the gate. The latch rotates between a locked position and an unlocked position. The holder includes a drawer removably coupled with the side portion. The drawer is selectively coupled with the latch in the locked position. The drawer slides between a retracted position and an extended position.

### CROSS-REFERENCE TO RELATED APPLICATIONS

The present application claims priority to Application No. 63/751,066 filed on Jan. 29, 2025, the disclosure of which is incorporated by reference herein in its entirety.

### FIELD OF THE INVENTION

The present subject matter relates generally to toothbrush holders and, more specifically, to toothbrush holders having a medicine container.

### BACKGROUND OF THE INVENTION

Patients that are prescribed medicine for daily, or even multi-daily, use may forget to take the prescribed medication. Typical pill holders, or medicine containers, may be placed in locations that are not accessed daily. For example, the patient may place a bottle container prescribed pills in a sink drawer or behind a mirror. Patients typically have activities to be completed at least once per day that are built into the habits of the patient. For example, patients may be diligent about brushing their teeth at least once per day.

A medication holder that is associated with a utensil used at least daily would be particularly advantageous for reminding patients to take their at least daily medication.

### BRIEF DESCRIPTION OF THE INVENTION

Aspects and advantages of the invention will be set forth in part in the following description, or may be apparent from the description, or may be learned through practice of the invention.

In one example embodiment, a combination utensil-medicine holder includes a base portion and a side portion coupled with the base portion. The holder also includes a top portion that has a rim, the rim defines a utensil aperture. The holder also includes a paddle assembly rotatably coupled with the side portion. The paddle assembly includes a paddle and a neck coupled with the paddle. The neck rotates about a first axis between holding position and a free position. The holder includes a cam rotatably coupled with the neck of the paddle assembly. The cam rotates between a level position and a non-level position. The holder includes a gate selectively engaged with the cam. The gate moves between a compressed position and a decompressed position. The holder includes a latch rotatably coupled with the gate. The latch rotates between a locked position and an unlocked position. The holder includes a drawer removably coupled with the side portion. The drawer is selectively coupled with the latch in the locked position. The drawer slides between a retracted position and an extended position.

In another example embodiment, a combination toothbrush-pill holder includes a base portion and a side portion coupled with the base portion. The holder includes a top portion that defines a utensil aperture. The holder includes a paddle assembly rotatably coupled with the side portion. The paddle assembly includes a paddle and a neck coupled with the paddle. The neck rotates about a first axis. The neck is configured to rotate caused by the paddle being actuated by a utensil. The holder includes a cam rotatably coupled with the neck of the paddle assembly. The cam is configured to rotate caused by the neck rotating. The holder includes a gate selectively engaged with the cam. The gate is configured to move caused by the cam engaging the gate. The holder includes a plurality of latches each rotatably coupled with the gate. The holder includes a plurality of drawers each having a locking feature selectively coupled with the plurality of latches, respectively. At least one latch of the plurality of latches is configured to uncouple from at least one locking feature of the plurality of drawers caused by the gate moving. At least one drawer of the plurality of drawers is configured to deploy caused by the at least one latch being uncoupled from the at least one locking feature.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 provides a perspective view of a combination toothbrush-pill holder according to aspects of the present disclosure.

FIG. 2 provides another perspective view of combination toothbrush-pill holder of FIG. 1 according to aspects of the present disclosure.

FIG. 3 provides a side, x-ray view of the combination toothbrush-pill holder of FIG. 1 according aspects of the present disclosure.

FIG. 4 provides a zoomed-in, x-ray view of the combination toothbrush-pill holder of FIG. 1 according to aspects of the present disclosure.

FIG. 5 provides an exploded view of the combination toothbrush-pill holder of FIG. 1.

FIG. 6 provides a top perspective, x-ray view of the combination toothbrush-pill holder of FIG. 1.

FIG. 7 provides another exploded view of the combination toothbrush-pill holder of FIG. 1.

FIG. 8 provides an exploded view of a drawer and a side portion of the combination toothbrush-pill holder of FIG. 1.

Repeat use of reference characters in the present specification and drawings is intended to represent the same or analogous features or elements of the present invention.

### DETAILED DESCRIPTION OF THE INVENTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

As used herein, the terms “includes” and “including” are intended to be inclusive in a manner similar to the term “comprising.” Similarly, the term “or” is generally intended to be inclusive (i.e., “A or B” is intended to mean “A or B or both”). Approximating language, as used herein throughout the specification and claims, is applied to modify any quantitative representation that could permissibly vary without resulting in a change in the basic function to which it is related. Accordingly, a value modified by a term or terms, such as “about,” “approximately,” and “substantially,” are not to be limited to the precise value specified. In at least some instances, the approximating language may correspond to the precision of an instrument for measuring the value. For example, the approximating language may refer to being within a 10 percent margin.

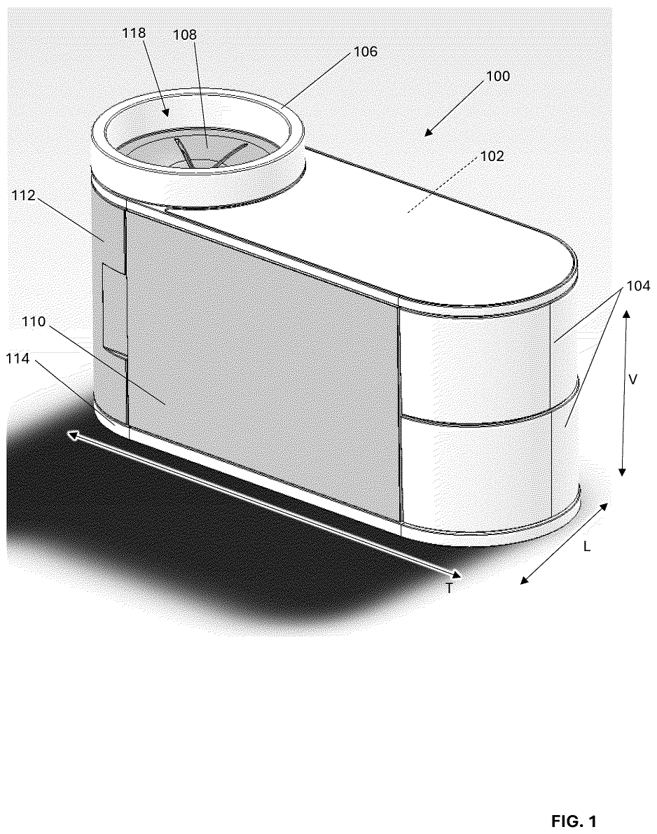

As used herein, the terms “first,” “second,” and “third” may be used interchangeably to distinguish one component from another and are not intended to signify location or importance of the individual components. Terms such as “inner” and “outer” refer to relative directions with respect to the interior and exterior of the combination toothbrush-pill holder. For example, “inner” or “inward” refers to the direction towards the interior of the combination toothbrush-pill holder. Terms such as “left,” “right,” “front,” “back,” “top,” or “bottom” are used with reference to the perspective of the appliance as illustrated in FIG. 1. For example, a user faces a front of the holder to place pills a front drawer of the holder.

Referring now to the drawings, FIG. 1 illustrates a perspective view of one embodiment of a combination toothbrush-pill holder 100 in accordance with aspects of the present subject matter.

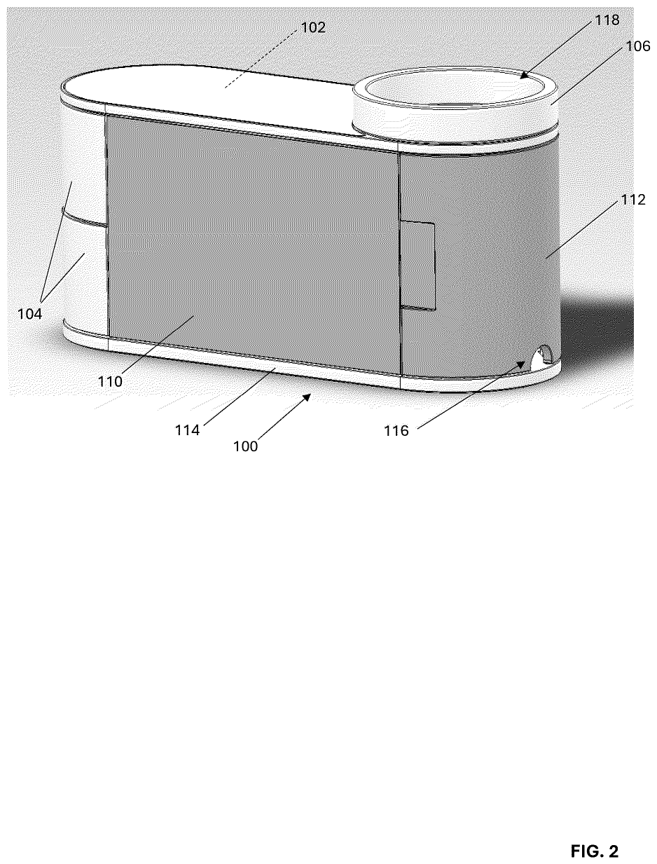

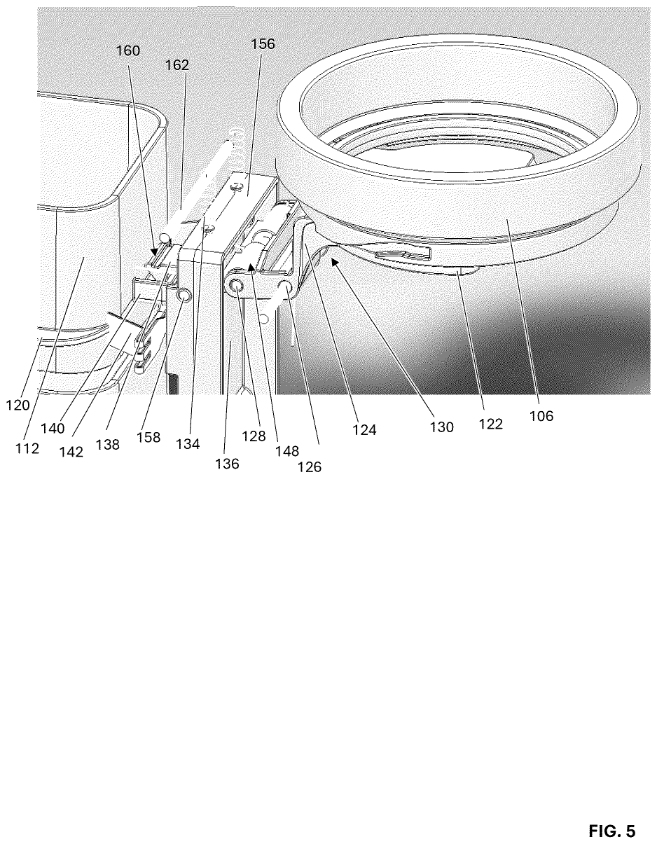

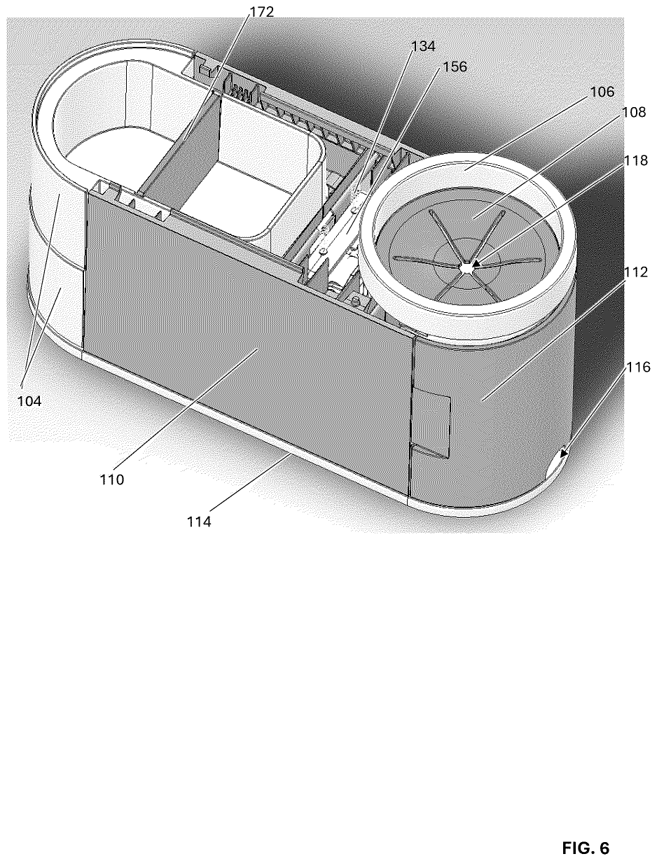

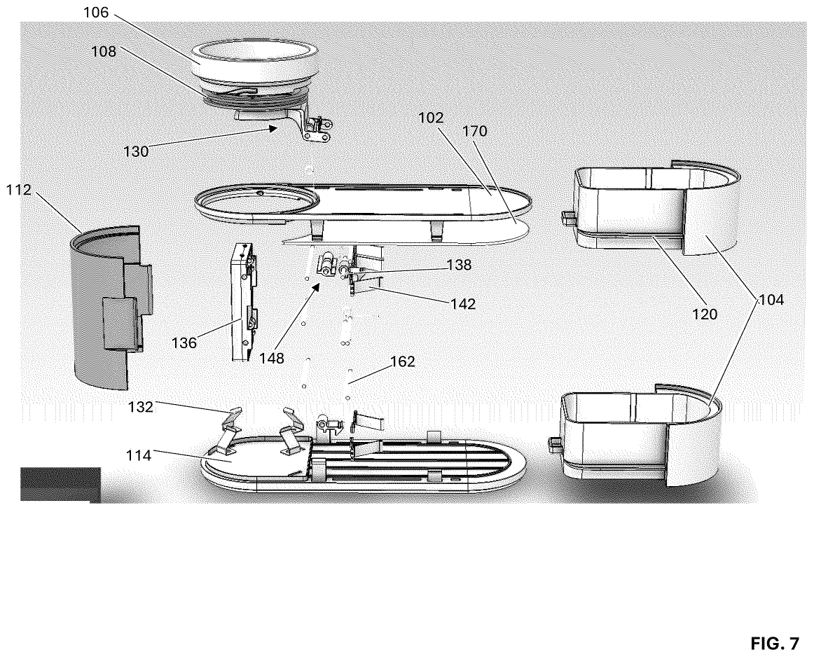

With reference to FIG. 1, the transverse direction, denoted by the arrow labeled “T,” corresponds to the axis along which terms such as “front” and “back” are oriented. The vertical direction, indicated by the arrow labeled “V,” aligns with the axis associated with terms such as “top” and “bottom.” The lateral direction, represented by the arrow labeled “L,” defines the axis along which terms such as “left” and “right” are referenced. These directional conventions provide a standardized framework for the spatial orientation of the combination toothbrush-pill holder 100 described herein and among FIGS. 1 through 8.

As used herein, the term “utensil” may refer to, but need not be limited to toothbrushes, toothpicks, hairbrushes, floss, mobile smart phones, and other utensils and items that are used at least daily, for example. The term “medicine” or “medication” may refer to one or more prescriptions that are to be consumed regularly, if not daily. For example, “pills” may be consumed daily or more often than daily (e.g., at morning and at night). As used herein, the term “cam” refers to a structure that rotates about an axis to actuate another different structure. “Cam” may include symmetrical structures (e.g., circular cylinders), and “cam” may include asymmetrical structures (e.g., oviform cylinders).

FIGS. 1 through 8 generally depict a combination utensil and medicine holder 100. The combination utensil-medicine holder 100 may also be referred to as a combination toothbrush-pill holder simply the holder. The holder 100 includes a base 114. The base 114, as illustrated in the examples of the figures, is generally oblong along the transverse direction T. The base 114 may be rounded, or arcuate, at transverse ends. Additionally, or alternatively, the base 114 may be straight, or prismatic, at lateral ends. The base 114 may be made from at least one of a metal, a metal alloy, a ceramic, or a polymeric material including being made from additive manufacturing and/or injection molding. The holder 100 also includes a side portion 110 coupled with the base 114. The side portion 110 generally extends along the vertical direction V and the transverse direction T. The side portion 110 is able to be coupled with the base 114 free of adhesives and fasteners. For example, the side portion 110 may couple with the base 114 via a friction fit, a keyed recess, etc., as would be understood by one of ordinary skill in the art.

The holder 100 may also include at least two side portions 110, or side panels, as illustrated in the examples of the figures. The at least two side portions 110 may couple with one another via a plurality of joists 162 that each extend along the lateral direction L. for example, the holder 100 may include a rib 164 coupled with and extending between the at least two side portions 110. The rib 164 may define a joist aperture 166 configured to receive and retain the joist 162. The side portions 110 may be spaced apart by about an equal distance that the base 114 extends in the lateral direction L. The distance that the base 114 extends in the lateral direction L, and thus the distance between the side portions 110, may be more than twice the average finger diameter of an adult human. The side portion 110 may be made from the same materials as the base 114. Additionally, or alternatively, the side portion 110 may be made from a different material as the base 114. The side portion 110 and the joist 162 are described in more detail below.

The holder 100 also includes a back portion 112, or back panel, coupled with the side portion 110. Additionally, or alternatively, the back portion 112 may be coupled with the base 114. The back portion 112 is able to be coupled with at least one of the base 114 or the side portion 110 free of adhesives and fasteners. For example, at least two side portions 110 may bias the back portion 112 to frictionally fit together. Additionally, or alternatively, the back portion 112 may couple with at least one of the base 114 or the side portion 110 via a keyed connection (e.g., flange and slot). The back portion 112 may be generally arcuate along a lateral-transverse plane defined by the lateral direction L and the transverse direction T. The back portion 112 may be made from the same materials as the base 114. Additionally, or alternatively, the back portion 112 may be made from a different material as the base 114. The back portion 112 is described in more detail below.

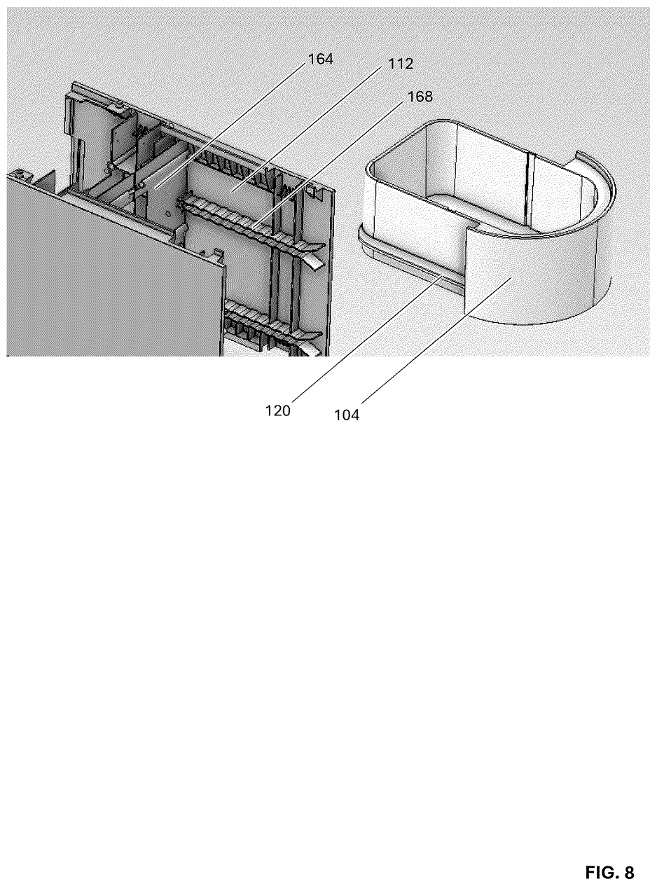

The holder 100 also includes at least one drawer 104 coupled with the side portion 110. The drawer 104 is configured to hold, among other things, medication (e.g., pills). Additionally, or alternatively, the drawer 104 may be configures to hold any item that can fit without the drawer 104 (e.g., a mouthguard, floss, etc.). The holder 100 may include a plurality of drawers 104 that are stacked vertically, horizontally, or in random order, for example. Alternatively, the holder 100 may also include one drawer 104 that occupies a front end of the holder 100 (e.g., one comparatively tall drawer). For example, the side portion 110 may include a side portion track 168, or receiving track. Additionally, or alternatively, the drawer 104 may include a drawer track 120. The side portion track 168 may be configured to receive the drawer track 120. Additionally, or alternatively, the side portion track 168 may include a chamfered opening, as illustrated in the examples of the figures. Additionally, or alternatively, the drawer track 120 may be configured to receive the side portion track 168. The drawer track 120 slides relative the side portion track 168; therefore, the drawer 104 is slidably coupled with the side portion 110. The drawer 104 moves, or slides, between a retracted position (FIG. 1) and an extended position (FIG. 8). The drawer 104 in the retracted position may align with the base along the transverse-lateral plane such that the drawer 104 is about flush with the holder 100. Additionally, or alternatively, the drawer 104 in the extended position may be partially coupled with the side portion 110. Additionally, or alternatively, the drawer 104 in the extended position may be uncoupled from the side portion 110 and spaced therefrom. Removing the drawer 104 from the side portion 110 may allow a user of the holder 100 to more easily access medication, or pills, that are held in the drawer 104. The drawer may be partially arcuate along a lateral-transverse plane defined by the lateral direction L and the transverse direction T at a transverse end of the holder 100. Additionally, or alternatively, the drawer 104 may be straight, or prismatic, along the lateral direction L such that the drawer track 120 is generally parallel with the side portion track 168. The drawer 104 may be made from the same materials as the base 114. Additionally, or alternatively, the drawer 104 may be made from a different material as the base 114. The drawer 104 is described in more detail below.

The holder 100 includes a top portion 102 coupled with at least one of the side portion 110 or the back portion 112. The top portion 102 is able to be coupled with at least one of the back portion 112 or the side portion 110 free of adhesives and fasteners. For example, at least two side portions 110 may bias the top portion 102 to frictionally fit together. Additionally, or alternatively, the top portion 102 may couple with at least one of the back portion 112 or the side portion 110 via a keyed connection (e.g., flange and slot). The top portion 102 defines a utensil aperture 118. The utensil aperture 118 is configured to receive a utensil (not shown). The holder 100 may further include a rim 106 coupled with the top portion 102 and extending vertically therefrom. The rim 106 may be removably coupled with the top portion 102. The rim 106 may further define the utensil aperture 118, as illustrated in the example figures.

The holder 100 may further include a first locator feature 108 coupled with the top portion 102 at the utensil aperture 118. Additionally, or alternatively, the first locator feature 108 may be directly coupled with the rim 106. The first locator feature 108 may further define the utensil aperture 118. The first locator feature 108 be configured to direct the utensil toward a center of the utensil aperture 118. For example, the first locator feature 108 may define the utensil aperture as star-shaped or snowflake-shaped. The first locator feature 108 may be generally deformable relative to the utensil and the top portion 102. For example, the first locator feature 108 may be made from silicone, rubber, a deformable polymeric material, or a deformable metallic material. The first locator feature 108 may be removably coupled with the top portion 102 such that a user can easily remove the first locator feature 108 to clean off residue from, for example, left over toothpaste (not shown).

Generally, the combination utensil and medicine holder 100 is configured to receive a utensil (e.g., a toothbrush) to cause the drawer 104 to move from the retracted position to the extended position. Examples of how the holder 100 releases the drawer 104 after the utensil is inserted into the utensil aperture 118 are described below.

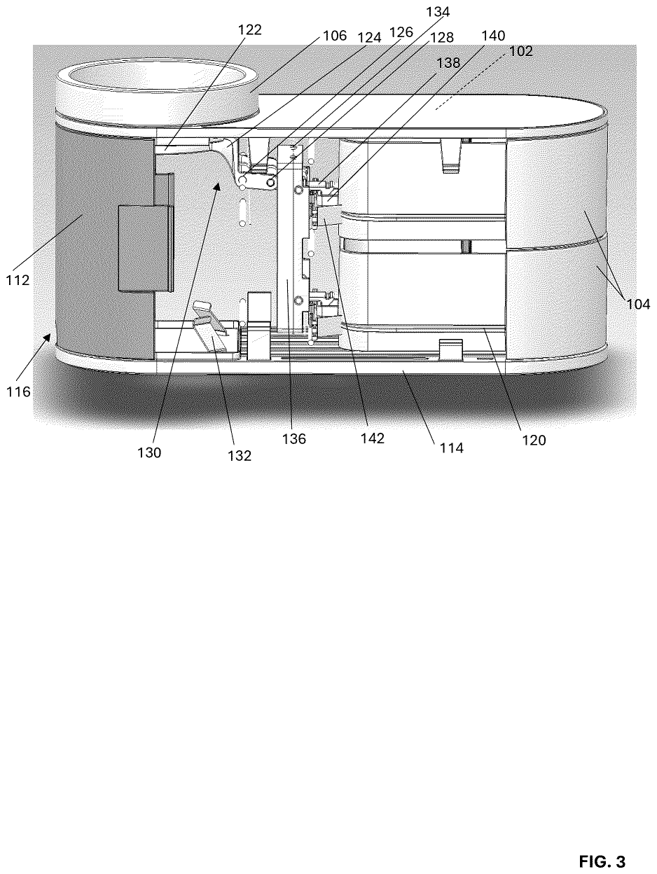

The holder 100 may include a paddle assembly 130. The paddle assembly 130 include a neck 124 rotatably coupled with the side portion 110. More specifically, the neck 124 may be coupled with a joist 162 extending between two side portions 110. The neck 124 rotates about a first axis of rotation 126 at the joist 162. The paddle assembly 130 further includes a paddle 122 coupled with the neck 124. The utensil may be inserted into the utensil aperture 118 to engage the paddle 122 and cause the neck to rotate about the first axis of rotation 126. Therefore, the neck 124 of the paddle assembly 130 rotates between a holding position (not shown) (when the utensil is inserted into the utensil aperture 118) and a free position (when the utensil is yet to be inserted into the utensil aperture 118). The paddle assembly 130 may include a paddle spring 152 coupled with the neck 124. The paddle spring 152 may bias the paddle assembly toward the free position. With reference to FIG. 3, the paddle 122 engaged by the utensil would rotate the neck 124 counterclockwise, from the perspective illustrated.

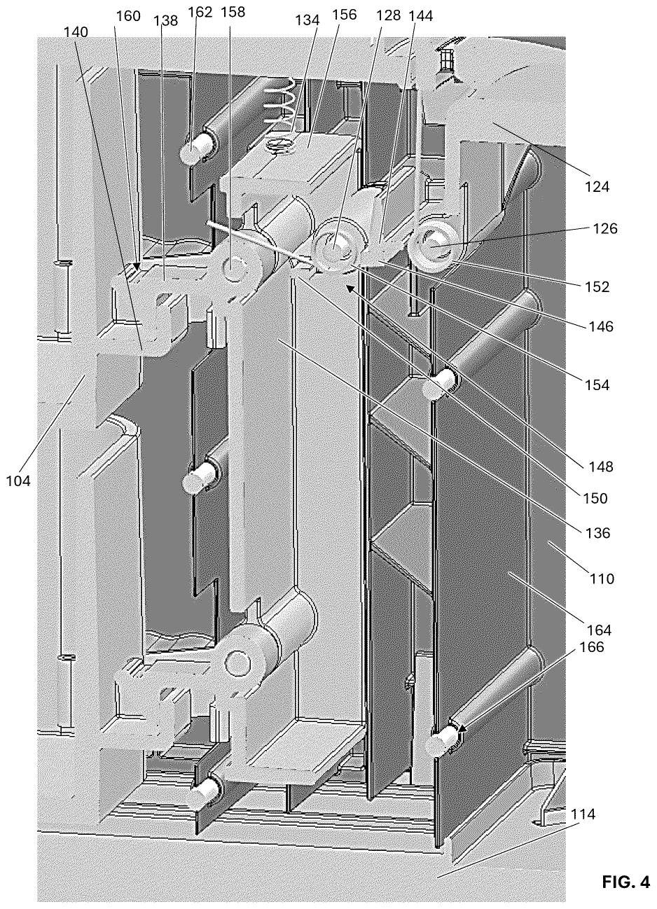

The holder 100 may include a cam 148 rotatably coupled with the neck 124 of the paddle assembly 130. The paddle assembly 130 may include a paddle brake 144 (FIG. 4) coupled with the neck 124. The cam 148 may include a cam brake 146 (FIG. 4) selectively engaged with the paddle brake 144. The cam 148 rotates between a level position (FIG. 4) and a non-level position (not shown). The cam 148 may rotate about a second axis of rotation 128. The holder 100 may include a cam spring 154 coupled with the cam 148. The cam spring 154 may bias the cam 148 toward the level position. Further, the neck 124 that rotates from the free position to the holding position also causes the cam 148 to translate along the vertical direction V. More specifically, the neck 124 that rotates from the free position to the holding position causes the cam 148 to translate vertically up. The cam 148 is described in more detail below.

The holder 100 may include a gate 136 positioned between a plurality of the ribs 164. For example, the gate 136 may be held upright between the ribs 164 that are transversely in front of the gate 136 and transversely behind the gate 136. The gate 136 may vertically engage the rib 164 that is vertically below the gate 136. The holder 100 may include a gate spring 134 coupled with the gate 136 and the top portion 102. The holder 100 may include a cam actuator 150 coupled with the cam 148. The gate 136 may include an upper portion 156 that is selectively engaged by the cam actuator 150. For example, the paddle assembly 130 may cause the cam 148 to translate vertically up. As the cam 148 translates vertically up, the cam actuator 150 may engage the upper portion 156 of the gate 136 to move the gate from a decompressed position (FIGS. 3 and 4) to a compressed position (not shown) where the gate 136 is vertically raised. The gate 136 in the compressed position may compress the gate spring 134 between the upper portion 156 of the gate 136 and the top portion 102 such that the gate spring 134 biases the gate 136 toward the decompressed position. As the gate 136 translates to the compressed position, the cam actuator 150 pushes on an underside of the upper portion 156 of the gate 136. Eventually, the cam actuator 150 slips past the underside of the upper portion 156 then the cam actuator 150 may engage an upper side of the upper portion 156 and the cam 148 would then rotate from the level position to the non-level position to slip past the upper side of the upper portion 156 to be back vertically underneath the upper portion 156 of the gate 136, as illustrated in the example figures.

The holder 100 may also include at least one latch 138 rotatably coupled with the gate 136. The latch 138 may rotate between a locked position (FIG. 4) and an unlocked position (not shown). The latch 138 may rotate about a third axis of rotation 158. The latch 138 may define a recess 160 that is configured to receive, for example, a joist 162, to retain the latch in the unlocked position. Additionally, or alternatively, the recess 160 may be configured to, for example, receive a spring. For example, the latch 138 may be coupled with a latch spring (not shown) that biases the latch 138 toward the locked position. The gate 136 that moves from the decompressed position to the compressed position translates the latch 138 vertically upward. The latch 138 may define a sloped surface.

Referencing the drawer 104 again, the drawer 104 includes a locking portion 140 selectively engaged with the latch 138. The locking portion 140 receives the latch 138 to retain the drawer in the retracted position. As the gate 136 moves from the decompressed position to the compressed position, the latch 138 moves vertically up and is removed from the locking portion 140 of the drawer 104. The drawer 104 is then free to slide to the extended position. For example, the holder 100 may include a drawer spring 142 that biases the drawer 104 toward the extend position away from the retracted position. Additionally, or alternatively, the drawer 104 may be slid back toward the retracted position and the sloped surface of the latch 138 may engage the locking portion 140 to rotate the latch to the unlocked position. Once the drawer is slid far enough into the retracted position, the latch 138 may reinsert into the locking portion 140.

Additionally, or alternatively, the holder 100 may permit less than all latches 138 to unlock from the locking portion 140 to deploy less than all drawer 104 from the retracted position to the extended position. For example, one insertion of the utensil may deploy a top-most drawer of the drawers 104, and a second insertion of the utensil may deploy a bottom-most drawer of the drawers 104.

In summary, the utensil may engage the paddle 122 to rotate the neck 124. The neck 124 rotating causes the cam 148 to translate. The cam 148 translating causes the cam actuator 150 to engage the upper portion 156 of the gate 136 to translate the gate 136. The gate 136 translating causes the latch 138 to become unlocked from the locking portion 140 of the drawer 104. The locking portion 140 that is unengaged from the latch 138 allows the drawer spring 142 to slide the drawer 104 from the retracted position to the extended position. The drawer 104 can be reinserted into the retracted position and the locking portion can re-engage the latch 138 to retain the drawer 104 in the retracted position even if the utensil is still being held within the utensil aperture 118.

Furthermore, the holder 100 may include a second locator feature 132 coupled with the base 114. The second locator feature 132 may be configured to receive the utensil and align the utensil centrally with the utensil aperture 118. Additionally, or alternatively, the second locator feature 132 may be configured to receive and retain a charging base of an electric utensil (e.g., an electric toothbrush). Furthermore, the back portion 112 may define a power aperture 116 that is configured to have a wire, or cord, extend through the back portion 112 at the power aperture 116. Even further, the holder 100 may include a reinforcement layer 170 coupled with the top portion 102. The reinforcement layer 170 may increase rigidity. Additionally, or alternatively, the reinforcement layer 170 may be made from a non-slip flexible material that allows a user of the holder 100 to place items on top of the holder 100.

With continued reference to the drawer 104, the holder 100 may include a divider partition 172 disposed within the drawer 104. The divider partition 172 may separate one medication from another medication, for example. The divider partition 172 may be removable to be cleaned, for example, or to compensate larger items to be held within the drawer 104.

Advantageously, the combination utensil-medicine holder described herein allows a user of a daily utensil to remember to take a prescription once the utensil is inserted into the holder. This will increase the likelihood of a patient taking a prescription daily, twice daily, or as often as they use the utensil. The utensil could be, for example, a toothbrush, that is used twice daily at least. Additionally, the drawer 104 is wide enough to allow a user to reach into the drawer to grab a medication, for example a pill.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A combination utensil-medicine holder comprises:
a base portion;
a side portion coupled with the base portion;
a top portion having a rim, the rim defining a utensil aperture;
a paddle assembly rotatably coupled with the side portion, the paddle assembly comprising:
a paddle; and
a neck coupled with the paddle, wherein the neck rotates about a first axis between holding position and a free position;
a cam rotatably coupled with the neck of the paddle assembly, wherein the cam rotates between a level position and a non-level position;
a gate selectively engaged with the cam, wherein the gate moves between a compressed position and a decompressed position;
a latch rotatably coupled with the gate, wherein the latch rotates between a locked position and an unlocked position; and
a drawer removably coupled with the side portion, wherein the drawer is selectively coupled with the latch in the locked position, and wherein the drawer slides between a retracted position and an extended position.

2. The combination utensil-medicine holder of claim 1, wherein the drawer is configured to slide from the retracted position to the extended position in response to indirect actuation from a utensil being inserted into the utensil aperture.

3. The combination utensil-medicine holder of claim 2, wherein the drawer is configured to slide from the extended position to the retracted position with the utensil present within the utensil aperture.

4. The combination utensil-medicine holder of claim 1, further comprising a back portion removably coupled with the side portion, wherein the back portion defines a power aperture configured to receive a wire of a utensil that is electric.

5. The combination utensil-medicine holder of claim 1, wherein the side portion and the base portion are coupled free of adhesives and fasteners.

6. The combination utensil-medicine holder of claim 1, wherein the side portion defines a first track, wherein the drawer defines a second track, and wherein the first track slidably couples with the second track.

7. The combination utensil-medicine holder of claim 6, wherein the one of the first track or the second track comprises a receiving track, and wherein the receiving track has a sinusoidal profile to reduce friction between the first track and the second track.

8. The combination utensil-medicine holder of claim 1, wherein the drawer in the extended position is uncoupled and spaced from the side portion.

9. The combination utensil-medicine holder of claim 1, further comprising a divider partition disposed within the drawer.

10. The combination utensil-medicine holder of claim 1, further comprising a drawer spring, wherein the drawer spring biases the drawer toward the extended position.

11. A combination toothbrush-pill holder comprising:
a base portion;
a side portion coupled with the base portion;
a top portion defining a utensil aperture;
a paddle assembly rotatably coupled with the side portion, the paddle assembly comprising:
a paddle; and
a neck coupled with the paddle, wherein the neck rotates about a first axis, wherein the neck is configured to rotate caused by the paddle being actuated by a utensil;
a cam rotatably coupled with the neck of the paddle assembly, wherein the cam is configured to rotate caused by the neck rotating;
a gate selectively engaged with the cam, wherein the gate is configured to move caused by the cam engaging the gate;
a plurality of latches each rotatably coupled with the gate;
a plurality of drawers each having a locking feature selectively coupled with the plurality of latches, respectively, wherein at least one latch of the plurality of latches is configured to uncouple from at least one locking feature of the plurality of drawers caused by the gate moving, and wherein at least one drawer of the plurality of drawers is configured to deploy caused by the at least one latch uncoupling from the at least one locking feature.

12. The combination toothbrush-pill holder of claim 11, wherein the plurality of drawer is configured to slide from the retracted position to the extended position in response to indirect actuation of a utensil being inserted into the utensil aperture.

13. The combination toothbrush-pill holder of claim 12, wherein the plurality of drawers slides from the extended position to the retracted position with the utensil present within the utensil aperture.

14. The combination toothbrush-pill holder of claim 11, further comprising a back portion removably coupled with the side portion, wherein the back portion defines a power aperture configured to receive a wire of a utensil that is electric.

15. The combination toothbrush-pill holder of claim 11, further comprising a first locator feature removably coupled with the top portion, wherein the first locator feature is configured to centrally align a utensil within the utensil aperture.

16. The combination toothbrush-pill holder of claim 15, further comprising a second locator feature coupled with the base portion, wherein the second locator feature is configured to at least partially retain the utensil within the combination toothbrush-pill holder.

17. The combination toothbrush-pill holder of claim 11, wherein the plurality of drawers in the extended position is uncoupled and spaced from the side portion.

18. The combination toothbrush-pill holder of claim 11, wherein the side portion defines a first track, wherein the plurality of drawers each defines a second track, and wherein the first track slidably couples with the second track.

19. The combination toothbrush-pill holder of claim 18, wherein one of the first track or the second track comprises a receiving track, and wherein the receiving track has a sinusoidal profile to reduce friction between the first track and the second track.

20. The combination toothbrush-pill holder of claim 11, further comprising a divider partition disposed within at least one drawer of the plurality of drawers.
